(19) United States
(12) Patent Application Publication
(10) Pub. No.: US 2020/0399175 A1
(43) Pub. Date: Dec. 24, 2020

(54) GLASS ARTICLES COMPRISING LIGHT EXTRACTION FEATURES AND METHODS FOR MAKING THE SAME

(71) Applicant: CORNING INCORPORATED, CORNING, NY (US)

(72) Inventors: Robert Stephen Wagner, Corning, NY (US); James Joseph Watkins, Corning, NY (US); James Andrew West, Painted Post, NY (US)

(21) Appl. No.: 16/088,147

(22) PCT Filed: Mar. 28, 2017
(86) PCT No.: PCT/US2017/024428

§ 371 Date: Sep. 25, 2018

Related U.S. Application Data
(60) Provisional application No. 62/314,662, filed on Mar. 29, 2016.

(51) Int. Cl. C03C 23/00; F21V 8/00; B23K 26/352; B23K 26/0622

(52) U.S. Cl. CPC C03C 23/0025; G02B 6/0036; B23K 2103/54; B23K 26/352; B23K 26/0622; G02B 6/0065

(57) ABSTRACT

A method for making a glass article comprising contacting a first surface of a glass substrate with a laser to produce a plurality of light extraction features having a diameter and a depth, wherein the light extraction features produce a color shift Δy of extracted light where Δy<0.01 per 500 mm of length. A glass article as described can comprise a first surface and an opposing second surface, wherein the first surface comprises a plurality of laser induced light extraction features, and wherein the plurality of laser induced light extraction features produces a color shift Δy<0.01 per 500 mm of length.

### CROSS-REFERENCE TO RELATED APPLICATIONS

This application claims the benefit of priority under 35 U.S.C. § 119 of U.S. Provisional Application Ser. No. 62/314,662 filed on Mar. 29, 2016, the content of which is relied upon and incorporated herein by reference in its entirety.

### FIELD OF THE DISCLOSURE

The disclosure relates generally to glass articles and display devices comprising such glass articles, and more particularly to glass light guides comprising light extraction features and methods for making the same.

### BACKGROUND

Liquid crystal displays (LCDs) are commonly used in various electronics, such as cell phones, laptops, electronic tablets, televisions, and computer monitors. Increased demand for larger, high-resolution flat panel displays drives the need for large high-quality glass substrates for use in the display. For example, glass substrates may be used as light guide plates (LGPs) in LCDs, to which a light source may be coupled. A common LCD configuration for thinner displays includes a light source optically coupled to an edge of the light guide. Light guide plates are often equipped with light extraction features on one or more surfaces to scatter light as it travels along the length of the light guide, thereby causing a portion of the light to escape the light guide and project toward the viewer. Engineering of such light extraction features to improve homogeneity of light scattering along the length of the light guide has been studied in an effort to generate higher quality projected images.

Currently, light guide plates can be constructed from plastic materials having high transmission properties, such as polymethyl methacrylate (PMMA) or methyl methacrylate styrene (MS). However, due to their relatively weak mechanical strength, it can be difficult to make light guides from PMMA or MS that are both sufficiently large and thin to meet current consumer demands. Plastic light guides may also necessitate a larger gap between the light source and guide due to low coefficients of thermal expansion, which can reduce optical coupling efficiency and/or require a larger display bezel. Glass light guides have been proposed as alternatives to plastic light guides due to their low light attenuation, low coefficient of thermal expansion, and high mechanical strength. Methods for providing light extraction features on plastic materials can include, for example, injection molding and laser damaging to produce light extraction features. While these techniques may work well with plastic light guides, injection molding and laser damaging can be incompatible with glass light guides. In particular, laser exposure may jeopardize glass reliability, e.g., may promote chipping, crack propagation, and/or sheet rupture.

In addition, laser damaging may produce extraction features that are too small to efficiently extract light from the light guide plate. Increasing the density of such small features may be possible but can increase the length of processing and, thus, the cost and/or time for production. Moreover, laser damaging of glass can create debris and/or defects around the extraction features. Such debris and defects can increase light extraction but, due to their inhomogeneity, may create high-frequency noise that can lead to image artifacts or defects (“mura”). Defects having various shapes and/or sizes can also create wavelength-dependent scattering, which can drive undesirable color shifting. Furthermore, the addition of energy to the glass article via laser can instigate various chemical reactions, which can generate gaseous products that redeposit on the surface of the glass article. These deposits and/or chemical changes in the vicinity of light extraction features can also generate color shift and/or create high-frequency noise.

Alternative methods for applying light extraction features to glass light guides can include printing techniques such screen printing or inkjet printing. Specifically, inkjet or screen printing can be used to create patterns on the light guide with white or scattering ink. However, printing light extraction features on glass may present other challenges. For example, the ink itself may absorb some of the light and generate a color shift. Accordingly, it would be advantageous to provide glass articles, such as light guide plates, for display devices that address the aforementioned drawbacks, e.g., glass light guide plates having light extraction features that provide enhanced image quality and reduced color shifting and/or high-frequency noise.

### SUMMARY

The disclosure relates, in various embodiments, to a method for making a glass article comprising contacting a first surface of a glass substrate with a laser to produce a plurality of light extraction features having a diameter and a depth, wherein the light extraction features produce a color shift of extracted light Δy<0.01 per 500 mm of length. In some embodiments the glass article has a concentric ring failure strength of greater than about 200 MPa. In some embodiments the laser is selected from the group consisting of CO₂ lasers, CO lasers, yttrium aluminum garnet (YAG) lasers, frequency tripled neodymium-doped YAG (Nd:YAG) lasers, and frequency tripled neodymium-doped yttrium orthovanadate (Nd:YVO4) lasers. In some embodiments an individual light extraction feature may have a minimum width at the first surface of between 1 micrometer (μm) and 500 micrometers, a maximum width at the first surface of between 1 micrometer and 500 micrometers, an aspect ratio at the first surface of between 1 and 10, or combinations thereof. In some embodiments an individual laser induced light extraction feature may have a ratio of depth to minimum width of 0.01 to 100. In some embodiments the glass article has a thickness of between 0.2 millimeters (mm) and 4 mm. In some embodiments the method further comprises the step of depositing a diffusing film, a brightness enhancing film, or both on the first surface or second surface. In some embodiments the method further comprises the step of curving the glass article with a radius of curvature between 2 meters (m) and 6 m. In some embodiments the step of contacting further comprises (a) controlling vertical position of a laser focus region, (b) controlling minimum laser spot radius, (c) controlling laser wavelength relative to material absorption, (d) controlling laser pulse energy, (e) controlling laser pulse length, (f) controlling laser spot velocity relative to the substrate velocity, (g) controlling laser pulse repetition rate, (h) controlling time between pulses, (i) controlling laser duty cycle, (j) controlling laser average power, or (k) a combination of steps (a)-(j) to obtain the plurality of light extraction features on the first surface in a pattern selected from the group consisting of random, arranged, repetitive, non-repetitive, symmetrical, and asymmetrical.

The disclosure also relates to a glass article comprising a first surface and an opposing second surface, wherein the first surface comprises a plurality of laser induced light extraction features, and wherein the plurality of laser induced light extraction features produces a color shift Δy<0.01 per 500 mm of length. In some embodiments the glass article has a concentric ring failure strength of greater than about 200 megaPascal (MPa). In some embodiments ones of the plurality of laser induced light extraction features have a diameter ranging from about 5 μm to about 1 mm and a depth ranging from about 1 μm to about 3 mm. In some embodiments ones of the plurality of laser induced light extraction features have a minimum width at the first surface of between 1 μm and 500 μm, a maximum width at the first surface of between 1 μm and 500 μm, an aspect ratio at the first surface of between 1 and 10, or combinations thereof. In some embodiments individual laser induced light extraction features can have a ratio of depth to minimum width of 0.01 to 100. In some embodiments the glass article has a thickness of between 0.2 mm and 4 mm. In some embodiments the glass article has a thickness of 0.7 mm, 1.1 mm or 2 mm. In some embodiments the glass article further comprises a diffusing film, a brightness enhancing film, or both. In some embodiments the glass article further comprises one or more light sources coupling light into one or more sides of the glass article. In some embodiments the plurality of laser induced light extraction features provides a light extraction uniformity of >80% across the glass article. In some embodiments the glass article is curved with a radius of curvature between 2 m and 6 m. In some embodiments the plurality of light extraction features is present on the first surface in a pattern selected from the group consisting of random, arranged, repetitive, non-repetitive, symmetrical, and asymmetrical. In some embodiments any one or combination of the depths, diameters, ratio of depth to diameter, and geometries of the concave light extraction features vary as a function of position on the first surface. In some embodiments the opposing second surface comprises a second plurality of light extraction features.

Embodiments disclosed herein provide several advantages over conventional techniques such as, but not limited to, printing technologies or the like. For example, for each new design iteration, screen printing requires fabrication and tuning of a new screen pattern or mask, whereas laser patterning according to embodiments described herein allows for rapid software changes to the extraction pattern, which reduces development costs. Additionally, screens used for printing need frequent cleaning and replacement, which increases operating costs and increases downtime, and both screen and inkjet printing require a separate curing step (either thermal or UV), which decreases throughput. Such conventional patterning techniques that add material to the glass (printing or microreplication) make the resulting light guide plate sensitive to the optical properties of those materials, which increases color shift. Furthermore, the potential for delamination offers up an additional failure mode for a light guide plate made by conventional techniques. Embodiments disclosed herein also provide several advantages over conventional CO₂ based (i.e., thermal) laser patterning technologies. For example, exemplary processes described herein yield parts with higher strength that are capable of being used in a curved display without post-CO₂ exposure/etch processes. Exemplary processes described herein also yield well defined features with minimal re-deposition of ablated material or crack formation that may add variability to a resulting light guide plate's optical output. Exemplary processes described herein also yield light guide plates having low color shift, minimize waste material, and do not require curing.

Additional features and advantages of the disclosure will be set forth in the detailed description that follows, and in part will be readily apparent to those skilled in the art from that description or recognized by practicing the methods as described herein, including the detailed description that follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings, wherein, when possible, like numerals refer to like components, it being understood that the appended figures are not necessarily drawn to scale.

FIG. 1 is an illustration of an exemplary light guide plate according to some embodiments;

FIG. 2 is an illustration of a light extraction pattern for some embodiments;

FIG. 3 is an illustration of a light extraction pattern for further embodiments;

FIG. 4 is an illustration of a light extraction pattern for additional embodiments;

FIGS. 5A-5C are confocal microscope images of exemplary laser features in some embodiments;

FIG. 6 is a depth profile of an exemplary laser feature of some embodiments;

FIG. 7 provides depth profiles of other exemplary laser features of other embodiments;

FIG. 8 is a three dimensional representation of an exemplary light extraction feature;

FIG. 9A is a plot of angular dependence of luminous intensity versus feature width for some embodiments;

FIG. 9B is a graph of three cross sections of FIG. 9A corresponding to a feature width of 50 microns, 100 microns, and 200 microns;

FIG. 10 is a plot of variation of peak luminous intensity of FIG. 9A;

FIG. 11A is a plot of angular dependence of luminous intensity versus feature width for other embodiments;

FIG. 11B is a graph of three cross sections of FIG. 11A corresponding to a feature depth of 10 microns, 20 microns, 50 microns, and 100 microns;

FIG. 12 is a plot of variation of peak luminous intensity of FIG. 11A;

FIGS. 13A and 13B are micrographs of light extraction features according to some embodiments;

FIG. 14 is a graph of failure probability for a concentric ring reliability test for some embodiments;

FIG. 15 is a simplified depiction of an exemplary concentric ring failure test;

FIG. 16A is an exemplary light guide plate made using embodiments described herein;

FIG. 16B is a light guide plate made using conventional techniques; and

FIG. 17 is a depiction of a process according to some embodiments.

### DETAILED DESCRIPTION

Glass Articles

Disclosed herein are glass articles comprising a first surface and an opposing second surface, wherein the first surface comprises a plurality of light extraction features. Exemplary glass articles can include, but are not limited to, glass light guide plates. Display devices comprising such glass articles are further disclosed herein.

The glass article or light guide plate may comprise any material known in the art for use in displays and other similar devices including, but not limited to, aluminosilicate, alkali-aluminosilicate, borosilicate, alkali-borosilicate, alumino-borosilicate, alkali-aluminoborosilicate, soda lime, and other suitable glasses. In certain embodiments, the glass article may have a thickness of less than or equal to about 3 mm, for example, ranging from about 0.3 mm to about 2 mm, from about 0.7 mm to about 1.5 mm, or from about 1.5 mm to about 2.5 mm, including all ranges and subranges therebetween. Non-limiting examples of commercially available glasses suitable for use as a light guide plate include, for instance, EAGLE XG®, Gorilla®, Iris™ Lotus™, and Willow® glasses from Corning Incorporated.

The glass article may comprise a first surface and an opposing second surface. The surfaces may, in certain embodiments, be planar or substantially planar, e.g., substantially flat and/or level. The first and second surfaces may, in various embodiments, be parallel or substantially parallel. The glass article may further comprise at least one side edge, for instance, at least two side edges, at least three side edges, or at least four side edges. By way of a non-limiting example, the glass article may comprise a rectangular or square glass article having four edges, although other shapes and configurations are envisioned and are intended to fall within the scope of the disclosure. The glass article may, for example, be substantially flat or planar, or may be curved around one or more axes.

Also disclosed herein is a laser patterning process in which a transparent glass light guide plate or substrate is patterned with refractive light-extraction features on one surface to produce a color shift Δy of the extracted light wherein Δy<0.01 per 500 mm of length, and/or a concentric-ring failure strength of the plate or substrate greater than about 200 MPa. In some embodiments, the laser can be a pulsed CO₂ laser, CO laser, or other suitable pulsed laser. In some embodiments, the laser pulse length can be between 10 and 500 microseconds and/or the repetition rate can be between 500 Hz and 20 kHz. In some embodiments, relative motion between the substrate and the laser can have a maximum velocity between 10 mm/s and 5 m/s. In further embodiments, a galvo system can be used to further increase the rate of patterning. In some embodiments, exemplary light extraction features can have a depth of between 1-200 μm, a minimum width at the glass surface of between 1 and 500 μm, a maximum width at the glass surface of between 1 and 500 μm, and/or an aspect ratio (ratio of maximum to minimum width) at the glass surface of between 1 and 10. In yet further embodiments, exemplary light extraction features can have a ratio of depth to minimum width of 0.01 to 100.

Further disclosed herein is a transparent glass light guide plate or substrate having a thickness between 0.2 and 4 mm (e.g., 0.7 mm, 1.1 mm, 2 mm, or the like) with a pattern of refractive light-extraction features on one surface that produces a color shift Δy<0.01 per 500 mm of length and/or a concentric ring failure strength of greater than about 200 MPa when measured in accordance with ASTM XXX. Such embodiments can be used as a light guide in a backlight unit having one or more diffusing films, brightness enhancing films, and with an LED(s) coupling light into one or more sides of the light guide. In some embodiments, an exemplary pattern of light-extraction features can provide light extraction uniformity of >80% across the light guide. In some embodiments, exemplary light guides can be used in a curved deployment with a radius of curvature between 2 and 6 meters. In further embodiments, exemplary light extraction features can have a depth of between 1-200 μm, a minimum width at the glass surface of between 1 and 500 μm, a maximum width at the glass surface of between 1 and 500 μm, and/or an aspect ratio (ratio of maximum to minimum width) at the glass surface of between 1 and 10. In yet further embodiments, exemplary light extraction features can have a ratio of depth to minimum width of 0.01 to 100.

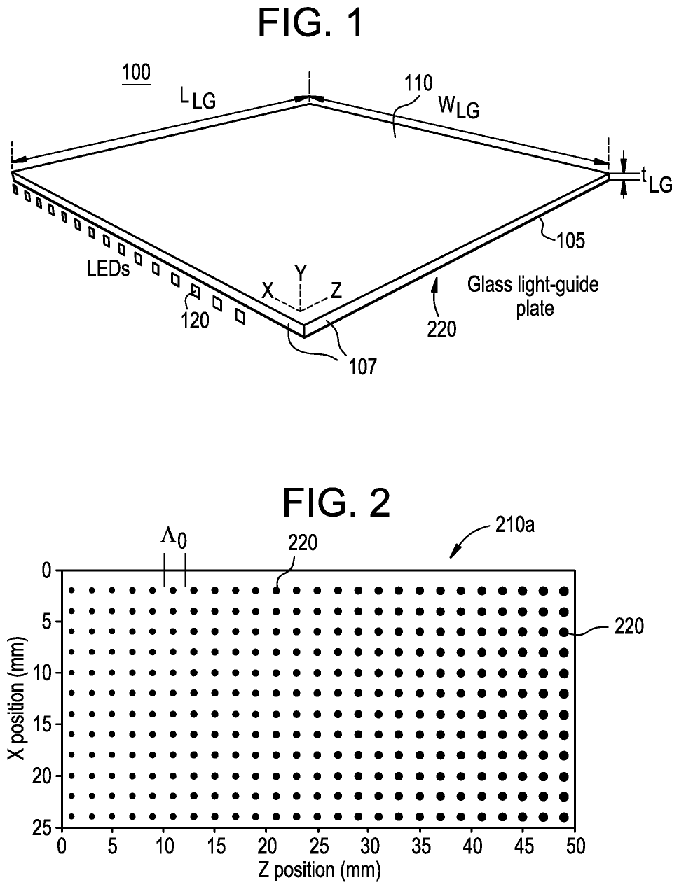

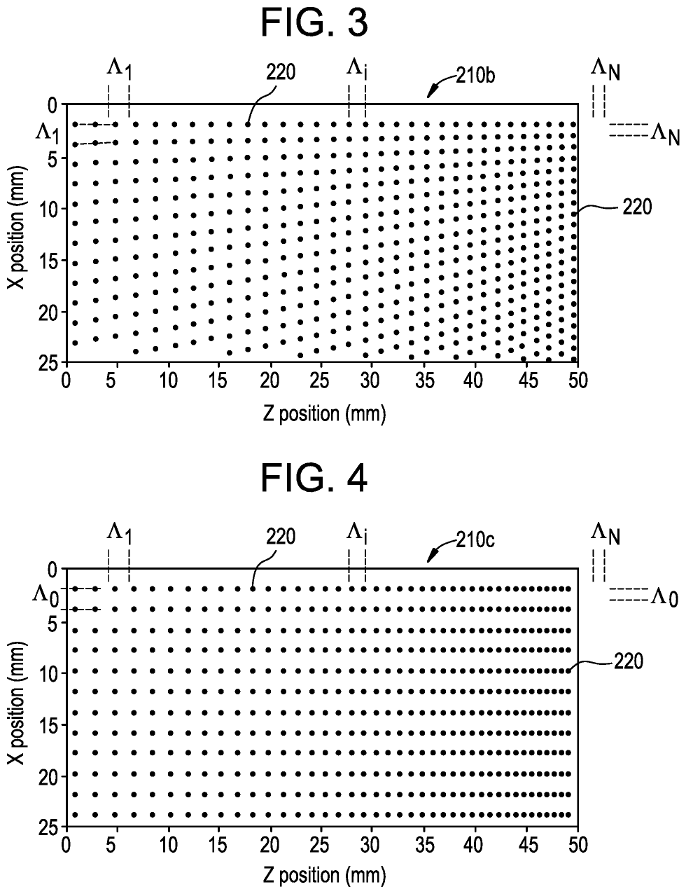

FIG. 1 is an illustration of an exemplary light guide plate according to some embodiments. With reference to FIG. 1, an exemplary glass article 100, e.g., glass light guide or light guide plate, can comprise a first surface 105, a second surface 110, a glass thickness t_{LG} extending between the first and second surfaces 105, 110, a panel width W_{LG} and a panel length L_{LG}. Optically coupled to one or more edges of the glass article 100 are one or more light sources 120 to provide an input of light to the one or more edges 107 of the glass article 100. While one array of light sources 120 on a single edge 107 is illustrated, such a depiction should not limit the scope of the claims appended herewith, as any number of or arrays of light sources 120 can be provided on multiple edges 107 of the glass article 100. As will be illustrated in FIGS. 2-3, a plurality of light extraction features 220 can be present on the first surface 105. It is to be understood, however, that these orientations and labels can be switched without limitation, the surfaces being referred to herein as “first” and “second” solely for the purposes of discussion. Moreover, it is possible, in non-limiting embodiments, for both surfaces of the glass article to comprise light extraction features. For example, the first surface may be provided with light extraction features according to the methods disclosed herein and the opposing second surface may be provided with light extraction features by the same or different methods known in the art. When both surfaces comprise light extraction features, the features can be identical or different in size, shape, spacing, geometry, and so on, without limitation.

The process of total internal reflection (TIR) confines the light in such a panel until the light hits a light-extraction feature that disrupts TIR. FIGS. 2, 3 and 4 illustrate non-limiting embodiments of light extraction patterns. With reference to FIG. 2, one pattern 210a of light extraction features according to some embodiments is depicted in which the pitch Λ₀ between light-extraction features 220 remains constant in the X and Z directions. In the depicted non-limiting embodiment, light coupling could occur along the X-axis at Z=0. Thus, to provide for substantially constant light extraction over an exemplary glass article 100, the areas of light extraction features 220 can increase linearly from X=0 to X=L. Of course, the depiction of features in FIG. 2 should not limit the scope of the claims appended herewith as the density of features can be varied, for example, in the Z direction by changing the spacing between neighboring features in both the X and Z directions (see FIG. 3) or by changing the spacing between neighboring features only in the Z direction, or in only the X direction (see FIG. 4). FIG. 3 provides an exemplary light extraction pattern 210b for a laser-patterned light-guide plate or glass article 100 in which the dimensions of the light-extraction features 220 remain constant in X and Z. Light coupling would be along the X-axis at Z=0. For constant light extraction, the density of the light extraction features 220 increases linearly from X=0 to X=L. This pattern increases the feature-to-feature spacing in both the X and Z dimensions. FIG. 4 provides an exemplary light extraction pattern 210c for a laser-patterned light-guide plate or glass article 100 in which the dimensions of the light-extraction features 220 remain constant in X and Z. Light coupling would be along the X-axis at Z=0. For constant light extraction, the density of the printed light extraction features 220 increases linearly from X=0 to X=L. This pattern increases the feature-to-feature spacing in only the Z dimension.

Using conventional techniques, the size of light-extraction features, the spacing of the features, and the precise pattern are determined by glass thickness, panel length, panel width, glass absorption, edge effects (i.e. reflectivity), and the desired efficiency of the panel where e=1−η_{eff}, where η_{eff}=P (Z=L)/P(Z=0). It follows that if light is constantly being extracted in a uniform fashion per unit length, the amount of light in the waveguide will decrease linearly by exactly the same amount per unit length minus any absorption. The basic linear increase in the area of the features according to conventional techniques would be a consequence of this linear decrease in waveguide power because the amount of scattered light p_{scatt} at position (X,Z) is proportional to the amount of light P(X,Z) in the waveguide at (X,Z) multiplied by the scattering coefficient S(X,Z) at (X,Z). This results in the following equation relating the scattering S(Z) to the power in the waveguide:

$$S ( z ) = \frac{{p}_{scatt}}{P ( z )} \qquad ( 1 )$$

With reference to equation (1), for a printed pattern the total scattering at position (X,Z) is proportional to the number of small scattering particles in the ink, which in turn is proportional to the volume of the ink dot. For screen printing, the ink dots are approximately equal in thickness, thus the total scattering at position (X,Z) is proportional to the area of the printed ink dot. In a typical screen-printed light-guide plate the scattering particles are several times larger than the wavelength of the light and the process can be considered as multi-particle Mie scattering. This scattering is mainly in the forward direction and has relatively little wavelength dependence when compared to the more familiar Rayleigh scattering from particles whose size is much less than the wavelength.

This same relationship between scattering and waveguide power can also be satisfied for an exemplary glass article having light extraction features according to embodiments described herein. In a laser-patterned waveguide according to exemplary embodiments, however, the scattering mechanism is very different from the small-particle scattering of the ink. For example, the laser-induced light extraction features are mainly refractive in nature and are composed of relatively smooth air/glass interfaces that disrupt the TIR. These features are much greater in size than the wavelength, and one expects the wavelength dependence of the refractive scattering to be less than that of conventional ink dots. If smaller features are created by the laser patterning, through re-deposition of material or by micro-cracking of the surrounding glass, the wavelength dependence may increase.

An exemplary laser pattering process according to exemplary embodiments uses a pulsed laser (CO₂, CO, or the like) focused by an optical system onto the surface of a transparent glass substrate. The feature size and morphology can be controlled by vertical position of the laser focus region z_{f}, minimum laser spot radius wₒ (1/e² of peak value) at the material, laser wavelength relative to material absorption A, laser pulse energy Eₚ, laser pulse length T_{dur}, laser spot velocity relative to the substrate velocity vₛ, laser pulse repetition rate fₚ, time between pulses 1/fₚ, laser duty cycle Dₚ=T_{dur}*fₚ, and/or laser average power P_{avg}=Eₚ*fₚ. For example, in some embodiments, a laser focal spot can be stationary while the glass article (e.g., light-guide plate) is moved laterally on translation stages. The scanning speed vₛ of the stages can be selected such that motion of the laser spot during laser exposure is minimized for approximately circular holes. If elliptical features are acceptable, the spot may move during the exposure time T_{dur}.

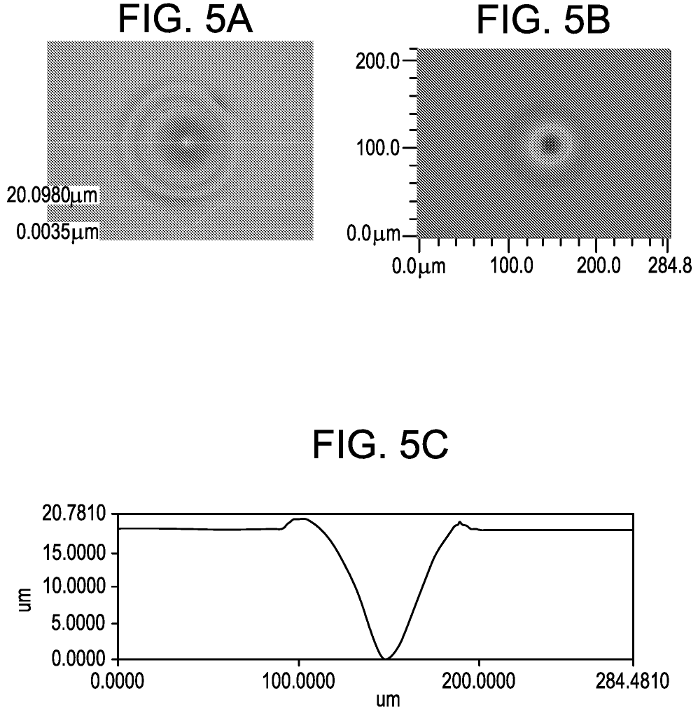

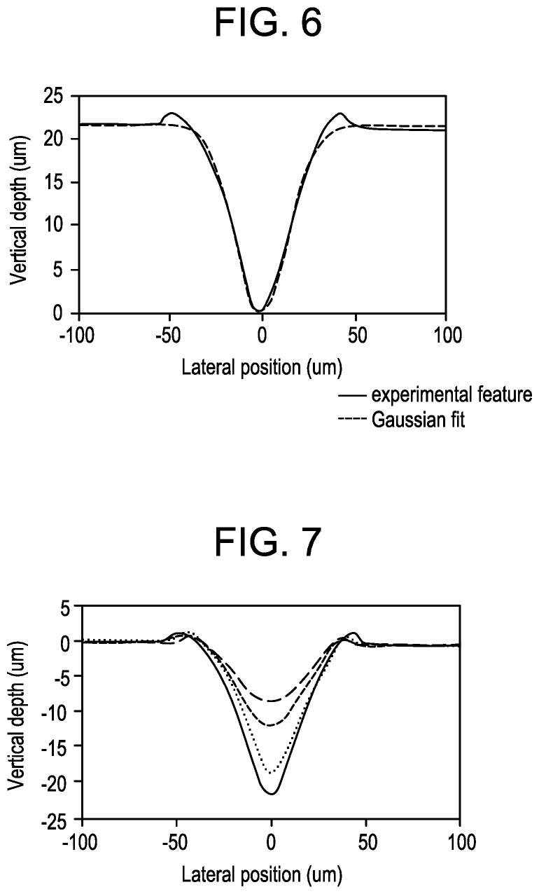

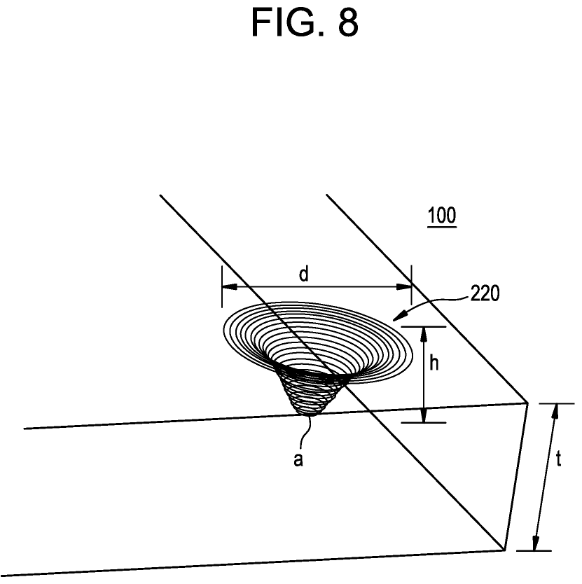

FIGS. 5A-5C, 6 and 7 illustrate dimensions of some exemplary laser-patterned features according to embodiments herein. FIGS. 5A-5C are confocal microscope images of exemplary laser features in some embodiments, FIG. 6 is a depth profile of an exemplary laser feature of some embodiments, and FIG. 7 provides depth profiles of other exemplary laser features of other embodiments. With reference to FIGS. 5A-5C, a confocal microscope image (FIG. 5A), a topography image (FIG. 5B), and a depth graph (FIG. 5C) of a single laser feature in a Corning Iris™ glass substrate are provided. The laser feature is depicted having a diameter of approximately 100 μm with a depth of approximately 20 μm. This depiction, however, should not limit the scope of the claims appended herewith as the feature diameter or width can vary (as discussed herein) and can be from 10 μm to 500 μm, from 50 μm to 200 μm, from 100 μm to 200 μm, and all subranges therebetween. Further, the depth of an exemplary feature can vary (as discussed herein) and can be from 5 μm to 200 μm, from 10 μm to 150 μm, from 20 μm to 100 μm, from 50 μm to 100 μm, and all subranges therebetween. As shown in FIG. 6, exemplary laser features can have an approximately Gaussian depth profile in cross-section with a small ring surrounding the central depression. This ring can be formed by melted material being pushed up out of the hole or cavity. As shown in FIG. 7, the depth of the feature can be controlled by the energy deposited in each laser pulse. FIG. 8 shows a three dimensional representation of an exemplary feature in which the light-extraction feature is treated as a simple Gaussian-shaped divot in the glass substrate.

While the light extraction feature is depicted as Gaussian, this should not limit the scope of the claims appended herewith, as the feature size and morphology can be controlled by vertical position of the laser focus region z_{f}, minimum laser spot radius wₒ (1/e² of peak value) at the material, laser wavelength relative to material absorption A, laser pulse energy E_{P}, laser pulse length τ_{dur}, laser spot velocity relative to the substrate velocity vₛ, laser pulse repetition rate fₚ, time between pulses 1/fₚ, laser duty cycle Dₚ=T_{dur}*fₚ, and/or laser average power P_{avg}=Eₚ*fₚ. Thus, the light extraction feature can be envisioned as a rounded crater positioned on the surface of the glass article, the dimensions of which need not be perfectly rounded, semi-spherical, or semi-ellipsoidal. Exemplary light extraction features can also be ellipsoidal, paraboloidal, hyperboloidal, frusto-conical, or can have any other suitable geometry.

Using the size of the laser focal spot and the intensity of the laser pulse, the morphology and scale of the light extraction features can also be selected to extract the required amount of light with the desired angular distribution. In some exemplary full back-light units (BLU) the angular distribution can also be further modified by a series of brightness enhancing films and diffusing films. The feature morphology is characterized by a maximum depth measured from the deepest point in the feature (e.g., apex a) to the plane that defines the untreated flat glass article surface. The light extraction features also have maximum and minimum transverse dimensions defined as the lateral dimensions with maximal and minimum values as measured in the plane of the flat untreated surface of the glass article measured from the point of maximal depth to the point where the depth has decreased to a value that is 1/e² times the maximal depth. For a light extraction feature of circular cross-section, the maximum and minimum transverse feature sizes would be nominally identical.

Accordingly, light extraction features 220 contained in a glass article can have any suitable diameter d and depth h. In some embodiments, light extraction features can have a diameter d ranging from about 5 μm to about 1 mm, such as from about 5 μm to about 500 μm, from about 10 μm to about 400 μm, from about 20 μm to about 300 μm, from about 30 μm to about 250 μm, from about 40 μm to about 200 μm, from about 50 μm to about 150 μm, from about 60 μm to about 120 μm, from about 70 μm to about 100 μm, or from about 80 μm to about 90 μm, including all ranges and subranges therebetween. According to various embodiments, the diameter d of each light extraction feature can be identical to or different from the diameter d of other light extraction features in the plurality of light extraction features on or in a glass article. The depth h of the light extraction features 220 can also range, for example, from about 1 μm to about 3 mm, such as from about 5 μm to about 2 mm, from about 10 μm to about 1.5 mm, from about 20 μm to about 1 mm, from about 30 μm to about 0.7 mm, from about 40 μm to about 0.5 mm, from about 50 μm to about 0.4 mm, from about 60 μm to about 0.3 mm, from about 70 μm to about 0.2 mm, or from about 80 μm to about 0.1 mm, including all ranges and subranges therebetween. According to various embodiments, the depth h of each light extraction feature can be identical to or different from the depth h of other light extraction features in the plurality of light extraction features 120.

As illustrated in FIG. 8, the depth h of the plurality of light extraction features 120 can be less than the thickness t of the glass article 100. In certain embodiments, the depth h can be substantially equal to the thickness t of the glass article (e.g., a light extraction feature extending from the first surface to the second surface through the thickness of the article). In yet further embodiments, the ratio t:h can range from about 100:1 to about 1:1, such as from about 50:1 to about 2:1, from about 25:1 to about 3:1, from about 20:1 to about 4:1, or from about 10:1 to about 5:1, including all ranges and subranges therebetween. In some embodiments the ratio h:d can range from about 100:1 to about 1:1, such as from about 50:1 to about 2:1, from about 25:1 to about 3:1, from about 20:1 to about 4:1, or from about 10:1 to about 5:1, including all ranges and subranges therebetween. Of course, the ratios t:h and h:d can vary from feature to feature in the plurality without limitation.

Further, exemplary light extraction features 220 can have an apex a (or lowest point in the feature), and the distance x between light extraction features can be defined as the distance between the apexes of two adjacent light extraction features. According to various embodiments, the distance x can range from about 5 μm to about 2 mm, such as from about 10 μm to about 1.5 mm, from about 20 μm to about 1 mm, from about 30 μm to about 0.5 mm, or from about 50 μm to about 0.1 mm, including all ranges and subranges therebetween. It is to be understood that the distance x between adjacent light extraction features can vary within the plurality of light extraction features 220, with different light extraction features spaced apart from one another at varying distances x.

According to various embodiments, light extraction features 220 on some portions of the glass article 100 (e.g., a glass light guide plate) may have a diameter d, depth h, spacing x, ratio t:h, and/or ratio h:d, while light extraction features 220 on other portions of the glass article 100 may have a second diameter d, depth h, spacing x, ratio t:h, and/or ratio h:d. For example, light extraction features 220 on portions of the glass article 100 (such as a light guide plate) adjacent or near the edges thereof or adjacent or near portions that receive light from a source (not shown) may have a first diameter d, depth h, spacing x, ratio t:h, and/or ratio h:d, and light extraction features 220 near the center of the glass article 107 or a predetermined distance from the light source 120 may have a second diameter d, depth h, spacing x, ratio t:h, and/or ratio h:d. In other embodiments, diameters, depths, ratios, and/or geometries of the light extraction features 220 may vary as a function of position on the surface of the glass article 100.

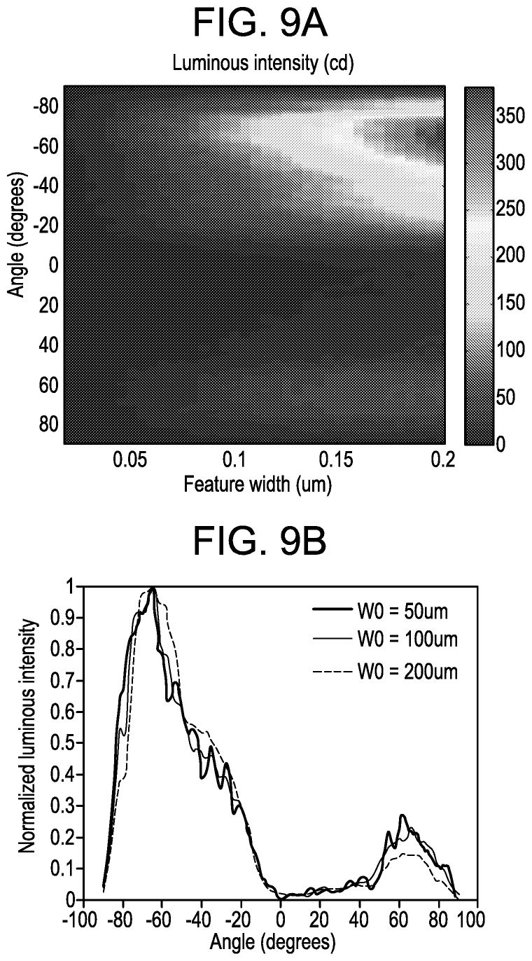

To understand the impact of the morphology of the laser-induced light extraction features on light extraction, one can use non-sequential ray tracing. To model the light extraction features, an array of light extraction features with the depth profile shown in FIG. 8 can be employed, whereby it can be expected that the angular distribution of the extracted light should remain constant when the light extraction feature morphology is kept constant but the light extraction feature size is scaled. This is confirmed in FIGS. 9A and 9B. FIG. 9A is a plot of the modeled angular dependence of the luminous intensity versus light extraction feature width for a light extraction feature of constant shape whereby the depth of the light extraction feature is one fifth of the light extraction feature width. The forward direction (away from the light source) corresponds to −90°. FIG. 9B illustrates three cross-sections of FIG. 9A and are shown corresponding to a light extraction feature having widths of 50, 100 and 200 μm. The peak height has been normalized to the maximum so that the shapes of the curves can be compared. With reference to FIGS. 9A-9B, it should be noted that the angular distributions are similar. For glass with this refractive index and Lambertian light sources, the peak light extraction occurs at approximately 60° with respect to the normal of the glass article surface and is concentrated in the forward direction, away from the input light source.

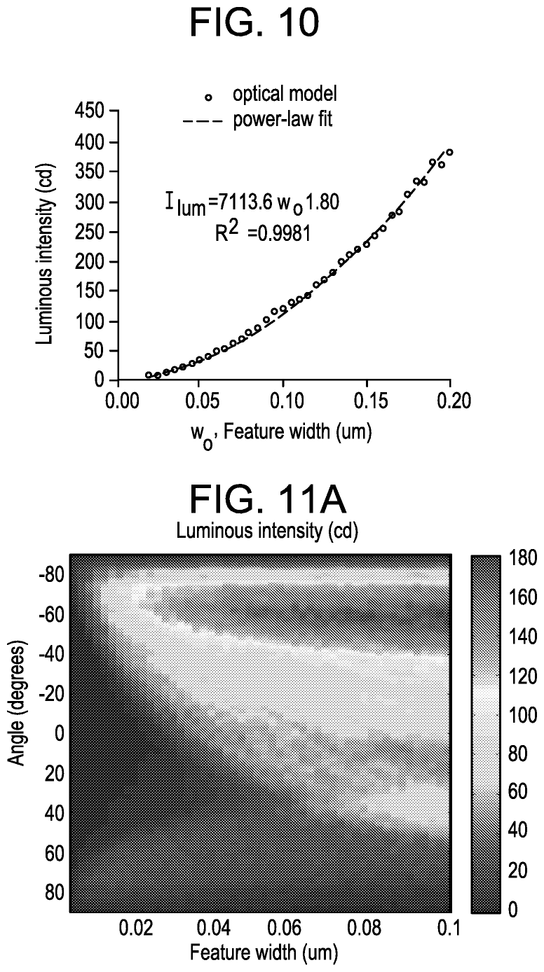

As the feature size is scaled larger, there is more surface area available for scattering. Thus, because the light extraction feature is scaled in all dimensions, the surface area grows with the square of the light extraction feature size. FIG. 10 is a plot of the variation of peak luminous intensity from FIG. 9A. With reference to FIG. 10, it can be observed that the amount of extracted light grows nonlinearly but is not quite quadratic and has an exponent of 1.80.

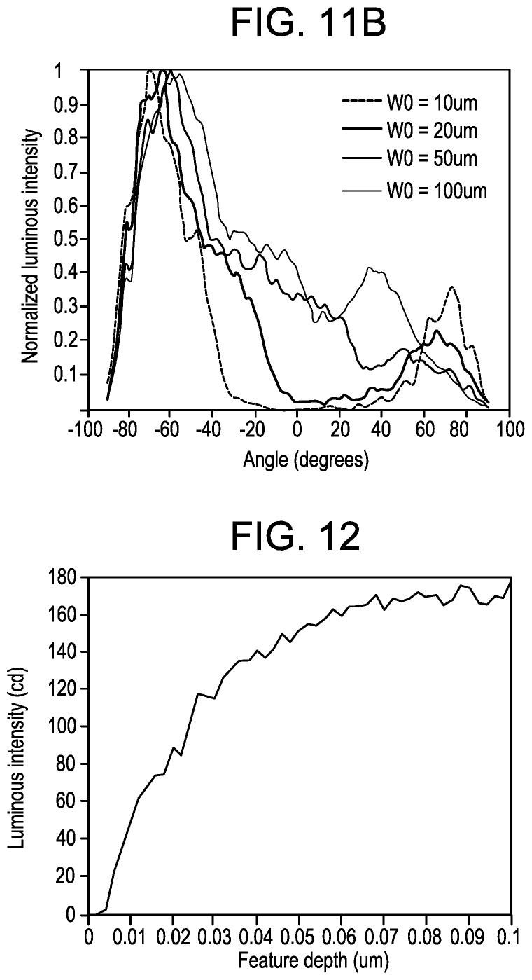

If the morphology is scaled differently in depth versus lateral size (as shown in the experimental depth profiles in FIG. 7), it can be observed that the angular distribution of the extracted light changes. This is expected because the sidewall angle of the light extraction features will depend on the ratio of the depth to the width. FIG. 11A is a plot of the modeled angular dependence of the luminous intensity versus light extraction feature width for a light extraction feature of constant width (100 μm) but varying depth. The forward direction (away from the light source) corresponds to −90°. FIG. 11B illustrates three cross-sections of FIG. 11A and are shown corresponding to a feature depths of 10, 20, 50, and 100 μm. The peak height has been normalized to the maximum so that the shapes of the curves can be compared. With reference to FIGS. 11A-11B, it should be noted that the angular distributions are different when the light extraction feature morphology is asymmetrically scaled. With reference to FIG. 11A, it can be observed that the changing angular distribution is a function of light extraction feature depth for a fixed 100 μm depth. FIG. 11B more clearly shows the change in the angular distribution by plotting the normalized distributions together. FIG. 12 is a plot of the variation of peak luminous intensity from FIG. 11A and illustrates that the peak luminous intensity remains near the 60° angle but the distribution broadens significantly. These depictions should not, however, limit the scope of the claims appended herewith as exemplary laser features can have different maximum and minimum transverse light extraction feature sizes. These can appear as Gaussian depth profiles with elliptical cross-sections instead of circular. The angular distributions and total light scattering from these light extraction features depend on the orientation. The steeper sides of the light extraction feature will cause a broader angular distribution in that direction. Also, more light is scattered when the broader side of the light extraction feature is oriented to face the source. Such light extraction features may be introduced intentionally or when the scanning speed of the laser is fast enough to cause significant movement of the laser spot during the laser pulse.

With conventional screen-printing technologies it is simple to change the area of individual scattering regions across the pattern to achieve a linear change in scattering required to uniformly extract light along the length of the light guide. With laser patterning, however, changing the light extraction feature width, size, and/or morphology across the glass article is much more challenging. In some embodiments, relative spacing between the laser-induced light extraction features can be modified while maintaining the shape and size of the light extraction features themselves. For example, two non-limiting approaches can be used to vary the density of the light extraction features in the Z direction: Change the spacing between neighboring light extraction features in both the X and Z directions (see FIG. 3) or change the spacing between neighboring light extraction features only in the Z direction, or in only the X direction (see FIG. 4).

In the foregoing approaches, one can assume that the light extraction features are arranged in regular rows in which each light extraction feature in a row has the same Z position. If the light extraction features are changed in both X and Z (as shown in FIG. 3), the rate of change of the pitch in the Z direction must be constant given by the relationship below:

$$Δ Λ = ( {Λ}_{i} - {Λ}_{i - 1} ) = - \frac{{Λ}_{1}^{2} ( 1 - {η}_{L G} )}{2 {L}_{L G}} \qquad ( 2 )$$

With reference to equation (2) and FIG. 3, Λ₁ represents the pitch near the light source at Z=0, η_{LG} represents the efficiency of the light guide or glass article, and L_{LG} represents the length of the glass article. The total number of rows N between Z=0 and L can be represented by:

$$N = \frac{2 {L}_{L G}}{{Λ}_{1} ( 1 + \sqrt{{η}_{L G}} )} \qquad ( 3 )$$

An exemplary pattern 210b produced by this recipe is shown in FIG. 3.

If the spacing is changed in only the Z direction, the pitch along the rows will be a constant Λ₀, while pitch in Z will change by a ratio represented below:

$$r = \frac{{Λ}_{i}}{{Λ}_{i - 1}} = \frac{2 {L}_{L G} - {Λ}_{1} ( 1 - {η}_{L G} )}{2 {L}_{L G} + {Λ}_{1} ( 1 - {η}_{L G} )} \qquad ( 4 )$$

For this scenario, the number of rows is given by:

$$N = \frac{log ( 1 - \frac{{L}_{L G} ( 1 - r )}{{Λ}_{1}} )}{log ( r )} \qquad ( 5 )$$

A variant on this last approach is to keep the spacing between rows constant at Λ₀, but change the pitch along the row in the X direction by the values given by equation (4), and again the number of rows would be given by equation (5). Finally, a more complex or even randomized pattern may be chosen in which the simple design rules given by equations (2)-(5) are not used. In such an embodiment, a computer model can be used to optimize the placement of individual holes, or an iterative experimental process can be used. Even in the case of the designs given above and described herein, the values of Λ₀ and Λ₁ may have to be determined experimentally to obtain the correct uniformity and efficiency.

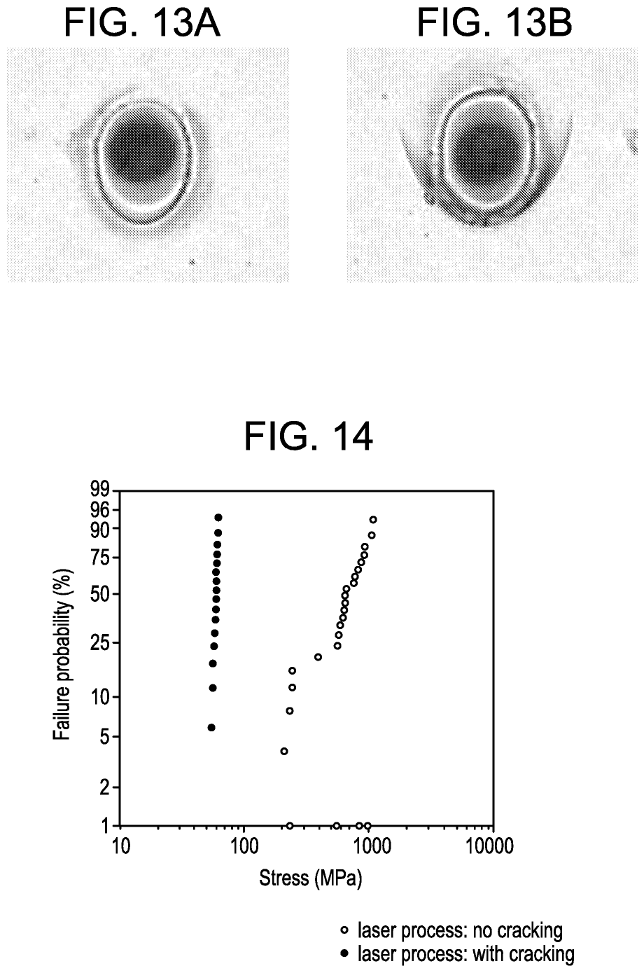

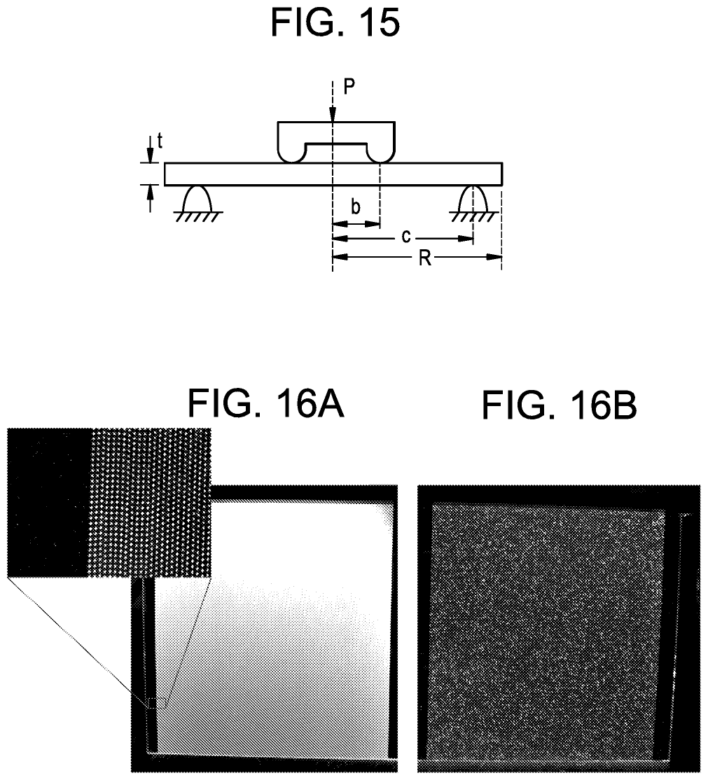

Exemplary laser processes according to embodiments herein can rapidly melt the glass causing it to form a crater-like feature on the surface (see, e.g., FIGS. 5A-5C, FIG. 13A). It was discovered that when exemplary laser processes occur too rapidly, an induced stress creates a characteristic fracture or microcrack depicted in FIG. 13B. These microcracks weaken the glass leading to higher failure rates (see FIG. 14 depicting the failure probability for a concentric ring reliability test comparing 1.1-mm thick laser-processed samples (25 laser-induced features spaced by 0.5-mm on a square grid) using laser-process parameters that produced microcracking (solid dots) with an optimized laser process that eliminated microcracking (open dots)) when subjected to additional stress such as bending or concentric ring testing (see FIG. 15 depicted a typical ring testing set up). Not only does microcracking weaken the material, but the small fractures also introduce refractive index changes that have sub-wavelength spatial frequencies. Such fractures have several uncontrolled consequences including point sources of high light extraction, broader angular distribution than the un-cracked features, and light scattering that has a greater wavelength dependence and can lead significant color differences between light extracted near Z=0 and light extracted at Z=Lc. Thus elimination of microcracking should be addressed to reduce color shift, improve light-extraction uniformity, and to improve mechanical reliability in exemplary embodiments (see FIG. 16A illustrating an exemplary light guide plate made using embodiments described herein and FIG. 16B illustrating a light guide plate made using conventional techniques where performance of the LGP is limited by microcracking).

Color shift is characterized by measuring variation in the chromaticity coordinate y along the length L using the CIE 1931 standard for color measurements. For glass light-guide plates the value of color shift Δy can be reported as Δy=y(L₂)−y(L₁) where L₂ and L₁ are Z positions along the panel or substrate direction away from the source launch and where L₂−L₁=0.5 meters. Exemplary light-guide plates have Δy<0.01, Δy<0.005, Δy<0.003, or Δy<0.001. To understand microcracking one must observe the material removal rate. To remove a volume V of material of density ρ and thermal capacitance Cₚ, energy Eₚ should be delivered such that:

Eₚ=ρVCₚ(Tᵥₐₚₒᵣ−T_{bulk}) (6)

where Tᵥₐₚₒᵣ and T_{bulk} represent the vaporization temperature of the material and the bulk substrate temperature, respectively. The laser parameters (pulse length τ_{dur}, duty cycle Dₚ, average power P_{avg}) can be adjusted so that energy Eₚ is delivered in a time τ_{dur} over a spot size with area A=πwₒ². A damage threshold exists when the energy is delivered with an instantaneous intensity of:

$${I}_{inst} = \frac{{P}_{i n s t}}{A} = \frac{{E}_{p}}{{τ}_{dur} A}$$

[watts/meter²] that exceeds the damage threshold of the material. This occurs when the laser pulse is focused too tightly or when the laser pulse arrives in too short a time.

For example, for a laser with an average power of P_{avg}=3 watts and a repetition rate fₚ=500 Hz, the pulse energy is 6 mJ. Assuming that damage occurs at pulse lengths below τ_{dur}<125 μs for a spot size of w₀=30 μm, an instantaneous power Pᵢₙₛₜ=48 W and the instantaneous intensity would be 17 mW/μm². If a 200 ρs pulse is used with wₒ=50 μm, the instantaneous intensity would be only 3.8 mW/μm^{t}, well below the damage threshold.

The spot size of the laser can be determined by the desired size of the light-extraction feature. As described above, the feature morphology determines the angular distribution of the scattered light and the total amount of scattered light. Thus, the optical scattering considerations may limit the light extraction feature shape to an approximately Gaussian spot with a width of 100 microns and a depth of 35 microns. A Gaussian profile of depth d and 1/e² width of wₒ has a volume of 2πdwₒ². An asymmetric or elliptical Gaussian spot would have a cross-sectional area of 2πdwₒₓw_{oy}.

For a given light extraction feature cross-sectional area A, the damage threshold determines the shortest single pulse that can be used without microcracking. If the laser is stationary, the pulse will create an undistorted light extraction feature. Although it is possible to step the laser beam across the glass article, a faster process can use a continuously scanned system that moves the glass article relative to the laser with velocity v. This may be accomplished by moving only the glass article, moving only the laser, or a combination of laser and substrate motion. During the time τ_{dur}, the glass article will move a distance V*τ_{dur} relative to the laser. This will cause a ‘blurring’ of the feature morphology in the direction of motion producing an elliptical spot if the un-scanned spot was circular. To maintain a circular spot, one would have to pre-compensate for the motion by forming an unscanned elliptical spot with the minor axis along the intended scan direction. Alternatively, one could add an additional galvo to the laser system to move the laser to match the scan velocity and thus eliminate the relative motion during the time τ_{dur}.

The final design of the system can be an optimization of τ_{dur} that balances the probability of microcracking against the total time to pattern an entire back-light light-guide. To increase the speed of writing, a galvo system can be added with an F-theta lens to essentially increase the duty cycle of the laser so that the time between pulses is shortened. In the previous example of the laser system with an average power of P_{avg}=3 watts, a repetition rate fₚ=500 Hz and a pulse length of τ_{dur}<125 μs, the duty cycle is only Dₚ=6%. With a galvo system the effective duty cycle could be over 60%.

Thus, as described above, it has been experimentally shown and demonstrated that laser induced light extraction features having varying lateral and depth dimensions can be made with no cracking at exemplary pulse lengths and spatial periods. Experiments were performed that resulted in exemplary glass articles (see FIG. 16A) that produced a color shift of the extracted light Δy<0.01 per 500 mm of length, Δy<0.005 per 500 mm, Δy<0.001 per 500 mm as well as a concentric-ring failure strength of the article that was greater than about 200 MPa, greater than 100 MPa, greater than 50 MPa, between 50 and 500 MPa, and all subranges therebetween. Exemplary light guide plates can include a thickness between 0.2 mm and 4 mm, between 0.7 mm and 2 mm, and all subranges therebetween. Exemplary light extraction features can have a depth of between 1-200 μm, a minimum width at the glass surface of between 1 and 500 μm, a maximum width at the glass surface of between 1 and 500 μm, and/or aspect ratio (ratio of maximum to minimum width) at the glass surface of between 1 and 10. In yet further embodiments, exemplary light extraction features can have a ratio of depth to minimum width of 0.01 to 100.

Such embodiments can be used as a light guide in a backlight unit having one or more diffusing films, brightness enhancing films, and with an LED(s) coupling light into one or more sides of the light guide. In some embodiments, an exemplary pattern of light-extraction features can provide light extraction uniformity of greater than 80% across the light guide. In some embodiments, exemplary light guides can be used in a curved deployment with a radius of curvature between 2 and 6 meters.

The glass articles and light guide plates disclosed herein may be used in various display devices including, but not limited to LCDs or other displays used in the television, advertising, automotive, and other industries. Traditional backlight units used in LCDs can comprise various components. One or more light sources 120 may be used, for example light-emitting diodes (LEDs) or cold cathode fluorescent lamps (CCFLs). Conventional LCDs may employ LEDs or CCFLs packaged with color converting phosphors to produce white light. According to various aspects of the disclosure, display devices employing the disclosed glass articles may comprise at least one light source emitting blue light (UV light, approximately 100-400 nm), such as near-UV light (approximately 300-400 nm). The light guide plates and devices disclosed herein may also be used in any suitable lighting applications such as, but not limited to, luminaries or the like. In some embodiments, the glass articles can be used as a light guide in display devices, such as LCDs, and a light source, e.g., LED, can be optically coupled to at least one edge of the light guide.

As used herein, the term “optically coupled” is intended to denote that a light source is positioned at an edge of the glass article so as to inject light into the guide. When light is injected into the glass article, e.g. glass light guide plate, according to certain embodiments, the light is trapped and bounces within the light guide due to TIR until it hits a light extraction feature on the first or second surface. As used herein, the term “light-emitting surface” is intended to denote a surface from which light is emitted from the light guide plate toward a viewer. For instance, the first or second surface can be a light-emitting surface. Similarly, the term “light-incident surface” is intended to denote a surface that is coupled to a light source, e.g., an LED, such that light enters the light guide. For example, the side edge of the light guide plate can be a light-incident surface.

Methods

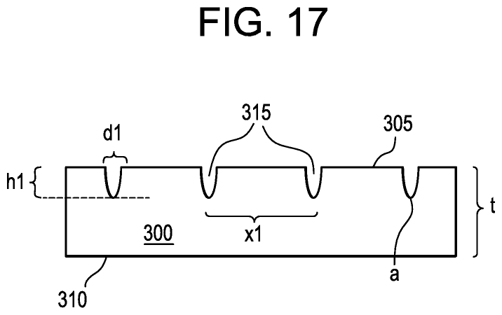

As discussed above, disclosed herein are methods for making glass articles or light guide plates, the methods comprising contacting a first surface of a glass substrate with a laser to produce light extraction features having a diameter and depth. Methods for making the glass articles disclosed herein will be discussed, without limitation, with reference to FIG. 17. A glass substrate 300 can be provided having a first surface 305, an opposing second surface 310, and a thickness t extending therebetween. The first or second surface of the glass article can be contacted with a laser, for example, by moving a laser along a predetermined path on the surface of a stationary glass article. Alternatively, the laser may be stationary and the glass article can be moved along the predetermined path. The predetermined path can be a line or a plurality of lines; however, other predetermined paths, including non-linear paths are envisioned. Moreover, more than one predetermined path can be traced on the surface to form a more complex pattern, which can be repetitive or non-repetitive, random or arranged, symmetrical or asymmetrical.

Contact with the laser, e.g., a CO₂ laser, CO laser, UV laser, or the like, can comprise single laser pulses along the predetermined path, or multiple pulses can be used to increase the depth and/or width of the features. The pulses can have, for example, a duration (or pulse width) of less than a second, less than 0.5 seconds, less than 0.1 seconds, less than 0.01 seconds, less than a nanosecond, or less than a picosecond. In some embodiments, the pulse width can range from about 10 nanoseconds to about 100 nanoseconds, such as from about 20 nanoseconds to about 90 nanoseconds, from about 30 nanoseconds to about 80 nanoseconds, from about 40 nanoseconds to about 70 nanoseconds, or from about 50 nanoseconds to about 60 nanoseconds, including all ranges and subranges therebetween. The dimension of the light extraction features (e.g., diameter and/or depth) can be controlled, e.g., by varying the number of pulse repetitions in a given location. According to various embodiments, the light extraction features can be deepened and/or widened at a rate of about 0.5 microns to about 3 microns per laser pulse, such as from about 1 μm to about 2.5 μm per laser pulse, or from about 1.5 μm to 2 μm per laser pulse, including all ranges and subranges therebetween. The number of pulses repeated for a give location can range, for example, from 1 to 100 pulses, such as from 2 to 90 pulses, from 3 to 80 pulses, from 5 to 70 pulses, from 10 to 60 pulses, from 20 to 50 pulses, or from 30 to 40 pulses, including all ranges and subranges therebetween.

The pulse repetition rate (or frequency) can range, for example, from about 1 kHz to about 150 kHz, such as from about 5 kHz to about 125 kHz, from about 10 kHz to about 100 kHz, from about 20 kHz to about 90 kHz, from about 30 kHz to about 80 kHz, from about 40 kHz to about 70 kHz, of from about 50 kHz to about 60 kHz, including all ranges and subranges therebetween. In additional embodiments, the pulse energy can range from about 10 microJoules (μJ) to about 200 μJ, such as from about 20 μJ to about 150 μJ, from about 30 μJ to about 120 μJ, from about 40 μJ to about 100 μJ, from about 50 μJ to about 90 μJ, or from about 60 μJ to about 80 μJ, including all ranges and subranges therebetween.

Non-limiting exemplary methods and lasers suitable for laser damaging and cutting glass are disclosed, for instance, in U.S. application Ser. Nos. 13/989,914; 14/092,536; 14/145,525; 14/530,457; 14/535,800; 14/535,754; 14/530,379; 14/529,801; 14/529,520; 14/529,697; 14/536,009; 14/530,410; and Ser. No. 14/530,244; and International Application Nos. PCT/EP14/055364; PCT/US15/130019; and PCT/US15/13026; all of which are incorporated herein by reference in their entireties. Lasers can operate at any wavelength suitable for damaging the surface of the glass substrate, such as UV (˜100-400 nm), visible (˜400-700 nm), and infrared (˜700 nm-1 mm) wavelengths. In some embodiments, the laser wavelength can range from about 200 nm to about 10 microns, such as from about 300 nm to about 5 microns, from about 400 nm to about 4 microns, from about 500 nm to about 3 microns, or from about 1 micron to about 2 microns, including all ranges and subranges therebetween.

A suitable laser process can include, for example, a CO₂ laser to quickly heat the glass to a temperature at, near, or above the glass strain point. CO₂ lasers can operate, for example, at wavelengths greater than about 1 μm, such as about 1.06 microns. In other embodiments, a UV laser can be used, such as a frequency tripled neodymium-doped yttrium aluminum garnet (Nd:YAG) or frequency tripled neodymium-doped yttrium orthovanadate (Nd:YVO4) lasers operating at a wavelength of about 355 nm. Alternatively, a YAG laser operating at 1064 nm can also be used. Suitable CO lasers or other lasers can be used in exemplary embodiments.

Irradiation of the glass substrate 300 with the laser along the predetermined path on the first or second surface can create a plurality of light extraction features 315 having a diameter d1 and a depth h1. As discussed above, various parameters can be selected to achieve the desired optical properties for the light guide. In some embodiments, the diameter d1 can range from about 1 μm to about 300 μm, such as from about 5 μm to about 250 μm, from about 10 μm to about 200 μm, from about 20 μm to about 150 μm, from about 30 μm to about 100 μm, from about 40 μm to about 90 μm, from about 50 μm to about 80 μm, or from about 60 μm to about 70 μm, including all ranges and subranges therebetween. According to various embodiments, the diameter d1 of each light extraction feature can be identical to or different from the diameter d1 of other light extraction features in the plurality.

With reference to FIG. 3, the laser can modify the glass substrate along a predetermined path to create light extraction features 315 having any desired depth h1. For example, the depth h1 can range from about 1 μm to about 3 mm, such as from about 5 μm to about 2 mm, from about 10 μm to about 1.5 mm, from about 20 μm to about 1 mm, from about 30 μm to about 0.7 mm, from about 40 μm to about 0.5 mm, from about 50 μm to about 0.4 mm, from about 60 μm to about 0.3 mm, from about 70 μm to about 0.2 mm, or from about 80 μm to about 0.1 mm, including all ranges and subranges therebetween. As illustrated in FIG. 3, the depth h1 of the plurality of light extraction features 315 can be less than the thickness t of the glass article. According to various embodiments, the depth h1 of each light extraction feature can be identical to or different from the depth h1 of other light extraction features in the plurality.

In certain embodiments, the depth h1 can be substantially equal to the thickness t of the glass substrate (e.g., a light extraction feature extending from the first surface to the second surface through the thickness of the substrate). In yet further embodiments, the ratio t:h1 can range from about 100:1 to about 1:1, such as from about 50:1 to about 2:1, from about 25:1 to about 3:1, from about 20:1 to about 4:1, or from about 10:1 to about 5:1, including all ranges and subranges therebetween. In some embodiments the ratio h1:d1 can range from about 100:1 to about 1:1, such as from about 50:1 to about 2:1, from about 25:1 to about 3:1, from about 20:1 to about 4:1, or from about 10:1 to about 5:1, including all ranges and subranges therebetween.

The light extraction features can have an apex a (or lowest point in the feature), and the distance x1 between light extraction features can be defined as the distance between the apexes of two adjacent light extraction features. According to various embodiments, the distance x1 can range from about 5 μm to about 2 mm, such as from about 10 μm to about 1.5 mm, from about 20 μm to about 1 mm, from about 30 μm to about 0.5 mm, or from about 50 μm to about 0.1 mm, including all ranges and subranges therebetween. It is to be understood that the distance x1 between each light extraction feature can vary in the plurality, with different extraction features spaced apart from one another at varying distances x1. While not shown, after contact with the laser, the glass substrate 300 comprising a plurality of light extraction features 315 can be subjected to a subsequent grinding, polishing, or etching step to remove impurities on the surface thereof. Suitable etchants include hydrofluoric acid (HF) and/or hydrochloric acid (HCl) or any other suitable mineral or inorganic acid, e.g., nitric acid (HNO₃), sulfuric acid (HSO₄), and the like, or combinations thereof.

The methods disclosed herein can be used to pattern the first and/or second surface of the glass article with a plurality of light extraction features. As used herein, the term “patterned” is intended to denote that the plurality of features are present on the surface of the glass article in any given pattern or design, which may, for example, be random or arranged, repetitive or non-repetitive, symmetrical or asymmetrical. According to various embodiments, the extraction features may be patterned in a suitable density so as to produce a substantially uniform illumination. For instance, the density of the light extraction features may vary along the length of the glass article (e.g., light guide plate), such as having a first density at a light-incident side of the article, with an increasing or decreasing density at various points along the length of the article.

In non-limiting embodiments, the glass article can be further processed before and/or after laser processing. For example, the glass article may be etched, ground and/or polished to achieve the desired thickness and/or surface quality. The glass may also be optionally cleaned and/or the surface of the glass may be subjected to a process for removing contamination, such as exposing the surface to ozone or other cleaning agents.

Compositions

The glass article may also be chemically strengthened, e.g., by ion exchange. During the ion exchange process, ions within a glass article at or near the surface of the glass article may be exchanged for larger metal ions, for example, from a salt bath. The incorporation of the larger ions into the glass can strengthen the article by creating a compressive stress in a near surface region. A corresponding tensile stress can be induced within a central region of the glass article to balance the compressive stress.

Ion exchange may be carried out, for example, by immersing the glass article in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer that imparts a surface compressive stress.

In various embodiments, the glass composition of the glass article may comprise between 60-80 mol % SiO₂, between 0-20 mol % Al₂O₃, and between 0-15 mol % B₂O₃, and less than 50 ppm iron (Fe) concentration. In some embodiments, there may be less than 25 ppm Fe, or in some embodiments the Fe concentration may be about 20 ppm or less. In various embodiments, the thermal conduction of the light guide plate 100 may be greater than 0.5 W/m/K. In additional embodiments, the glass article may be formed by a polished float glass, a fusion draw process, a slot draw process, a redraw process, or another suitable forming process.

According to one or more embodiments, the LGP can be made from a glass comprising colorless oxide components selected from the glass formers SiO₂, Al₂O₃, and B₂O₃. The exemplary glass may also include fluxes to obtain favorable melting and forming attributes. Such fluxes include alkali oxides (Li₂O, Na₂O, K₂O, Rb₂O and Cs₂O) and alkaline earth oxides (MgO, CaO, SrO, ZnO and BaO). In one embodiment, the glass contains constituents in the range of 60-80 mol % SiO₂, in the range of 0-20 mol % Al₂O₃, in the range of 0-15 mol % B₂O₃, and in the range of 5 and 20% alkali oxides, alkaline earth oxides, or combinations thereof.

In some glass compositions described herein, SiO₂ can serve as the basic glass former. In certain embodiments, the concentration of SiO₂ can be greater than 60 mole percent to provide the glass with a density and chemical durability suitable for a display glasses or light guide plate glasses, and a liquidus temperature (liquidus viscosity), which allows the glass to be formed by a downdraw process (e.g., a fusion process). In terms of an upper limit, in general, the SiO₂ concentration can be less than or equal to about 80 mole percent to allow batch materials to be melted using conventional, high volume, melting techniques, e.g., Joule melting in a refractory melter. As the concentration of SiO₂ increases, the 200 poise temperature (melting temperature) generally rises. In various applications, the SiO₂ concentration is adjusted so that the glass composition has a melting temperature less than or equal to 1,750° C. In various embodiments, the mol % of SiO₂ may be in the range of about 60% to about 80%, or alternatively in the range of about 66% to about 78%, or in the range of about 72% to about 80%, or in the range of about 65% to about 79%, and all subranges therebetween. In additional embodiments, the mol % of SiO₂ may be between about 70% to about 74%, or between about 74% to about 78%. In some embodiments, the mol % of SiO₂ may be about 72% to 73%. In other embodiments, the mol % of SiO₂ may be about 76% to 77%.

Al₂O₃ is another glass former used to make the glasses described herein. Higher mole percent Al₂O₃ can improve the glass's annealing point and modulus. In various embodiments, the mol % of Al₂O₃ may be in the range of about 0% to about 20%, or alternatively in the range of about 4% to about 11%, or in the range of about 6% to about 8%, or in the range of about 3% to about 7%, and all subranges therebetween. In additional embodiments, the mol % of Al₂O₃ may be between about 4% to about 10%, or between about 5% to about 8%. In some embodiments, the mol % of Al₂O₃ may be about 7% to 8%. In other embodiments, the mol % of Al₂O₃ may be about 5% to 6%.

B₂O₃ is both a glass former and a flux that aids melting and lowers the melting temperature. It has an impact on both liquidus temperature and viscosity. Increasing B₂O₃ can be used to increase the liquidus viscosity of a glass. To achieve these effects, the glass compositions of one or more embodiments may have B₂O₃ concentrations that are equal to or greater than 0.1 mole percent; however, some compositions may have a negligible amount of B₂O₃. As discussed above with regard to SiO₂, glass durability is very important for display applications. Durability can be controlled somewhat by elevated concentrations of alkaline earth oxides, and significantly reduced by elevated B₂O₃ content. Annealing point decreases as B₂O₃ increases, so it may be helpful to keep B₂O₃ content low. Thus, in various embodiments, the mol % of B₂O₃ may be in the range of about 0% to about 15%, or alternatively in the range of about 0% to about 12%, or in the range of about 0% to about 11%, in the range of about 3% to about 7%, or in the range of about 0% to about 2%, and all subranges therebetween. In some embodiments, the mol % of B₂O₃ may be about 7% to 8%. In other embodiments, the mol % of B₂O₃ may be about 0% to 1%.

In addition to the glass formers (SiO₂, Al₂O₃, and B₂O₃), the glasses described herein also include alkaline earth oxides. In one embodiment, at least three alkaline earth oxides are part of the glass composition, e.g., MgO, CaO, and BaO, and, optionally, SrO. The alkaline earth oxides provide the glass with various properties important to melting, fining, forming, and ultimate use. Accordingly, to improve glass performance in these regards, in one embodiment, the (MgO+CaO+SrO+BaO)/Al₂O₃ ratio is between 0 and 2.0. As this ratio increases, viscosity tends to increase more strongly than liquidus temperature, and thus it is increasingly difficult to obtain suitably high values for T₃₅ₖ−T_{liq}. Thus in another embodiment, the ratio (MgO+CaO+SrO+BaO)/Al₂O₃ is less than or equal to about 2. In some embodiments, the (MgO+CaO+SrO+BaO)/Al₂O₃ ratio is in the range of about 0 to about 1.0, or in the range of about 0.2 to about 0.6, or in the range of about 0.4 to about 0.6. In detailed embodiments, the (MgO+CaO+SrO+BaO)/Al₂O₃ ratio is less than about 0.55 or less than about 0.4.

For certain embodiments of this disclosure, the alkaline earth oxides may be treated as what is in effect a single compositional component. This is because their impact upon viscoelastic properties, liquidus temperatures and liquidus phase relationships are qualitatively more similar to one another than they are to the glass forming oxides SiO₂, Al₂O₃ and B₂O₃. However, the alkaline earth oxides CaO, SrO and BaO can form feldspar minerals, notably anorthite (CaAl₂Si₂O₈) and celsian (BaAl₂Si₂O₈) and strontium-bearing solid solutions of same, but MgO does not participate in these crystals to a significant degree. Therefore, when a feldspar crystal is already the liquidus phase, a superaddition of MgO may serve to stabilize the liquid relative to the crystal and thus lower the liquidus temperature. At the same time, the viscosity curve typically becomes steeper, reducing melting temperatures while having little or no impact on low-temperature viscosities.

The addition of small amounts of MgO may benefit melting by reducing melting temperatures and forming by reducing liquidus temperatures and increasing liquidus viscosity, while preserving high annealing points. In various embodiments, the glass composition comprises MgO in an amount in the range of about 0 mol % to about 10 mol %, or in the range of about 1.0 mol % to about 8.0 mol %, or in the range of about 0 mol % to about 8.72 mol %, or in the range of about 1.0 mol % to about 7.0 mol %, or in the range of about 0 mol % to about 5 mol %, or in the range of about 1 mol % to about 3 mol %, or in the range of about 2 mol % to about 10 mol %, or in the range of about 4 mol % to about 8 mol %, and all subranges therebetween.

Without being bound by any particular theory of operation, it is believed that calcium oxide present in the glass composition can produce low liquidus temperatures (high liquidus viscosities), high annealing points and moduli, and CTE's in the most desired ranges for display and light guide plate applications. It also contributes favorably to chemical durability, and compared to other alkaline earth oxides, it is relatively inexpensive as a batch material. However, at high concentrations, CaO increases the density and CTE. Furthermore, at sufficiently low SiO₂ concentrations, CaO may stabilize anorthite, thus decreasing liquidus viscosity. Accordingly, in one or more embodiment, the CaO concentration can be between 0 and 6 mol %. In various embodiments, the CaO concentration of the glass composition is in the range of about 0 mol % to about 4.24 mol %, or in the range of about 0 mol % to about 2 mol %, or in the range of about 0 mol % to about 1 mol %, or in the range of about 0 mol % to about 0.5 mol %, or in the range of about 0 mol % to about 0.1 mol %, and all subranges therebetween.

SrO and BaO can both contribute to low liquidus temperatures (high liquidus viscosities). The selection and concentration of these oxides can be selected to avoid an increase in CTE and density and a decrease in modulus and annealing point. The relative proportions of SrO and BaO can be balanced so as to obtain a suitable combination of physical properties and liquidus viscosity such that the glass can be formed by a downdraw process. In various embodiments, the glass comprises SrO in the range of about 0 to about 8.0 mol %, or between about 0 mol % to about 4.3 mol %, or about 0 to about 5 mol %, 1 mol % to about 3 mol %, or about less than about 2.5 mol %, and all subranges therebetween. In one or more embodiments, the glass comprises BaO in the range of about 0 to about 5 mol %, or between 0 to about 4.3 mol %, or between 0 to about 2.0 mol %, or between 0 to about 1.0 mol %, or between 0 to about 0.5 mol %, and all subranges therebetween.

In addition to the above components, the glass compositions described herein can include various other oxides to adjust various physical, melting, fining, and forming attributes of the glasses. Examples of such other oxides include, but are not limited to, TiO₂, MnO, Fe₂O₃, ZnO, Nb₂O₅, MoO₃, Ta₂O₅, WO₃, Y₂O₃, La₂O₃ and CeO₂ as well as other rare earth oxides and phosphates. In one embodiment, the amount of each of these oxides can be less than or equal to 2.0 mole percent, and their total combined concentration can be less than or equal to 5.0 mole percent. In some embodiments, the glass composition comprises ZnO in an amount in the range of about 0 to about 3.5 mol %, or about 0 to about 3.01 mol %, or about 0 to about 2.0 mol %, and all subranges therebetween. The glass compositions described herein can also include various contaminants associated with batch materials and/or introduced into the glass by the melting, fining, and/or forming equipment used to produce the glass. The glasses can also contain SnO₂ either as a result of Joule melting using tin-oxide electrodes and/or through the batching of tin containing materials, e.g., SnO₂, SnO, SnCO₃, SnC₂O₂, etc.

The glass compositions described herein can contain some alkali constituents, e.g., these glasses are not alkali-free glasses. As used herein, an “alkali-free glass” is a glass having a total alkali concentration that is less than or equal to 0.1 mole percent, where the total alkali concentration is the sum of the Na₂O, K₂O, and Li₂O concentrations. In some embodiments, the glass comprises Li₂O in the range of about 0 to about 3.0 mol %, in the range of about 0 to about 3.01 mol %, in the range of about 0 to about 2.0 mol %, in the range of about 0 to about 1.0 mol %, less than about 3.01 mol %, or less than about 2.0 mol %, and all subranges therebetween. In other embodiments, the glass comprises Na₂O in the range of about 3.5 mol % to about 13.5 mol %, in the range of about 3.52 mol % to about 13.25 mol %, in the range of about 4 to about 12 mol %, in the range of about 6 to about 15 mol %, or in the range of about 6 to about 12 mol %, and all subranges therebetween. In some embodiments, the glass comprises K₂O in the range of about 0 to about 5.0 mol %, in the range of about 0 to about 4.83 mol %, in the range of about 0 to about 2.0 mol %, in the range of about 0 to about 1.0 mol %, or less than about 4.83 mol %, and all subranges therebetween.

In some embodiments, the glass compositions described herein can have one or more or all of the following compositional characteristics: (i) an As₂O₃ concentration of at most 0.05 mole percent; (ii) an Sb₂O₃ concentration of at most 0.05 mole percent; (iii) a SnO₂ concentration of at most 0.25 mole percent.

As₂O₃ is an effective high temperature fining agent for display glasses, and in some embodiments described herein, As₂O₃ is used for fining because of its superior fining properties. However, As₂O₃ is poisonous and requires special handling during the glass manufacturing process. Accordingly, in certain embodiments, fining is performed without the use of substantial amounts of As₂O₃, i.e., the finished glass has at most 0.05 mole percent As₂O₃. In one embodiment, no As₂O₃ is purposely used in the fining of the glass. In such cases, the finished glass will typically have at most 0.005 mole percent As₂O₃ as a result of contaminants present in the batch materials and/or the equipment used to melt the batch materials.

Although not as toxic as As₂O₃, Sb₂O₃ is also poisonous and requires special handling. In addition, Sb₂O₃ raises the density, raises the CTE, and lowers the annealing point in comparison to glasses that use As₂O₃ or SnO₂ as a fining agent. Accordingly, in certain embodiments, fining is performed without the use of substantial amounts of Sb₂O₃, i.e., the finished glass has at most 0.05 mole percent Sb₂O₃. In another embodiment, no Sb₂O₃ is purposely used in the fining of the glass. In such cases, the finished glass will typically have at most 0.005 mole percent Sb₂O₃ as a result of contaminants present in the batch materials and/or the equipment used to melt the batch materials.

Compared to As₂O₃ and Sb₂O₃ fining, tin fining (i.e., SnO₂ fining) is less effective, but SnO₂ is a ubiquitous material that has no known hazardous properties. Also, for many years, SnO₂ has been a component of display glasses through the use of tin oxide electrodes in the Joule melting of the batch materials for such glasses. The presence of SnO₂ in display glasses has not resulted in any known adverse effects in the use of these glasses in the manufacture of liquid crystal displays. However, high concentrations of SnO₂ are not preferred as this can result in the formation of crystalline defects in display glasses. In one embodiment, the concentration of SnO₂ in the finished glass is less than or equal to 0.25 mole percent, in the range of about 0.07 to about 0.11 mol %, in the range of about 0 to about 2 mol %, and all subranges therebetween.

Tin fining can be used alone or in combination with other fining techniques if desired. For example, tin fining can be combined with halide fining, e.g., bromine fining. Other possible combinations include, but are not limited to, tin fining plus sulfate, sulfide, cerium oxide, mechanical bubbling, and/or vacuum fining. It is contemplated that these other fining techniques can be used alone. In certain embodiments, maintaining the (MgO+CaO+SrO+BaO)/Al₂O₃ ratio and individual alkaline earth concentrations within the ranges discussed above makes the fining process easier to perform and more effective.

In various embodiments, the glass may comprise RₓO where R is Li, Na, K, Rb, Cs, and x is 2, or R is Zn, Mg, Ca, Sr or Ba, and x is 1. In some embodiments, RₓO—Al₂O₃>0. In other embodiments, 0<RₓO—Al₂O₃<15. In some embodiments, RₓO/Al₂O₃ is between 0 and 10, between 0 and 5, greater than 1, or between 1.5 and 3.75, or between 1 and 6, or between 1.1 and 5.7, and all subranges therebetween. In other embodiments, 0<RₓO—Al₂O₃<15. In further embodiments, x=2 and R₂O—Al₂O₃<15, <5, <0, between −8 and 0, or between −8 and −1, and all subranges therebetween. In additional embodiments, R₂O—Al₂O₃<0. In yet additional embodiments, x=2 and R₂O—Al₂O₃—MgO>−10, >−5, between 0 and −5, between 0 and −2, >−2, between −5 and 5, between −4.5 and 4, and all subranges therebetween. In further embodiments, x=2 and RₓO/Al₂O₃ is between 0 and 4, between 0 and 3.25, between 0.5 and 3.25, between 0.95 and 3.25, and all subranges therebetween. These ratios play significant roles in establishing the manufacturability of the glass article as well as determining its transmission performance. For example, glasses having RₓO—Al₂O₃ approximately equal to or larger than zero will tend to have better melting quality but if RₓO—Al₂O₃ becomes too large of a value, then the transmission curve will be adversely affected. Similarly, if RₓO—Al₂O₃ (e.g., R₂O—Al₂O₃) is within a given range as described above then the glass will likely have high transmission in the visible spectrum while maintaining meltability and suppressing the liquidus temperature of a glass. Similarly, the R₂O—Al₂O₃—MgO values described above may also help suppress the liquidus temperature of the glass.

In one or more embodiments and as noted above, exemplary glasses can have low concentrations of elements that produce visible absorption when in a glass matrix. Such absorbers include transition elements such as Ti, V, Cr, Mn, Fe, Co, Ni and Cu, and rare earth elements with partially-filled f-orbitals, including Ce, Pr, Nd, Sm, Eu, Tb, Dy, Ho, Er and Tm. Of these, the most abundant in conventional raw materials used for glass melting are Fe, Cr and Ni. Iron is a common contaminant in sand, the source of SiO₂, and is a typical contaminant as well in raw material sources for aluminum, magnesium and calcium. Chromium and nickel are typically present at low concentration in normal glass raw materials, but can be present in various ores of sand and must be controlled at a low concentration. Additionally, chromium and nickel can be introduced via contact with stainless steel, e.g., when raw material or cullet is jaw-crushed, through erosion of steel-lined mixers or screw feeders, or unintended contact with structural steel in the melting unit itself. The concentration of iron in some embodiments can be specifically less than 50 ppm, more specifically less than 40 ppm, or less than 25 ppm, and the concentration of Ni and Cr can be specifically less than 5 ppm, and more specifically less than 2 ppm. In further embodiments, the concentration of all other absorbers listed above may be less than 1 ppm for each. In various embodiments the glass comprises 1 ppm or less of Co, Ni, and Cr, or alternatively less than 1 ppm of Co, Ni, and Cr. In various embodiments, the transition elements (V, Cr, Mn, Fe, Co, Ni and Cu) may be present in the glass at 0.1 wt % or less. In some embodiments, the concentration of Fe can be <about 50 ppm, <about 40 ppm, <about 30 ppm, <about 20 ppm, or <about 10 ppm. In other embodiments, Fe+30Cr+35Ni <about 60 ppm, <about 50 ppm, <about 40 ppm, <about 30 ppm, <about 20 ppm, or <about 10 ppm.

Even in the case that the concentrations of transition metals are within the above described ranges, there can be matrix and redox effects that result in undesired absorption. As an example, it is well-known to those skilled in the art that iron occurs in two valences in glass, the +3 or ferric state, and the +2 or ferrous state. In glass, Fe³⁺ produces absorptions at approximately 380, 420 and 435 nm, whereas Fe²⁺ absorbs mostly at IR wavelengths. Therefore, according to one or more embodiments, it may be desirable to force as much iron as possible into the ferrous state to achieve high transmission at visible wavelengths. One non-limiting method to accomplish this is to add components to the glass batch that are reducing in nature. Such components could include carbon, hydrocarbons, or reduced forms of certain metalloids, e.g., silicon, boron or aluminum. However it is achieved, if iron levels were within the described range, according to one or more embodiments, at least 10% of the iron in the ferrous state and more specifically greater than 20% of the iron in the ferrous state, improved transmissions can be produced at short wavelengths. Thus, in various embodiments, the concentration of iron in the glass produces less than 1.1 dB/500 mm of attenuation in the glass article. Further, in various embodiments, the concentration of V+Cr+Mn+Fe+Co+Ni+Cu produces 2 dB/500 mm or less of light attenuation in the glass article when the ratio (Li₂O+Na₂O+K₂O+Rb₂O+Cs₂O+MgO+ZnO+CaO+SrO+BaO)/Al₂O₃ for borosilicate glass is between 0 and 4.

The valence and coordination state of iron in a glass matrix can also be affected by the bulk composition of the glass. For example, iron redox ratio has been examined in molten glasses in the system SiO₂—K₂O—Al₂O₃ equilibrated in air at high temperature. It was found that the fraction of iron as Fe³⁺ increases with the ratio K₂O/(K₂O+Al₂O₃), which in practical terms will translate to greater absorption at short wavelengths. In exploring this matrix effect, it was discovered that the ratios (Li₂O+Na₂O+K₂O+Rb₂O+Cs₂O)/Al₂O₃ and (MgO+CaO+ZnO+SrO+BaO)/Al₂O₃ can also be important for maximizing transmission in borosilicate glasses. Thus, for the RₓO ranges described above, transmission at exemplary wavelengths can be maximized for a given iron content. This is due in part to the higher proportion of Fe²⁺, and partially to matrix effects associated with the coordination environment of iron.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes examples having two or more such light sources unless the context clearly indicates otherwise. Likewise, a “plurality” is intended to denote “more than one.” As such, a “plurality of light extraction features” includes two or more such features, such as three or more such features, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

6. The method of claim 1, wherein a thickness of the glass article is in a range between 0.2 mm and 4 mm.

7. The method of claim 1 further comprising depositing a diffusing film, a brightness enhancing film, or both on the first surface or second surface.

8. The method of claim 1 further comprising curving the glass article with a radius of curvature between 2 m and 6 m.

9. The method of claim 1, wherein the step of contacting further comprises:
(a) controlling vertical position of a laser focus region,
(b) controlling minimum laser spot radius,
(c) controlling laser wavelength relative to material absorption,
(d) controlling laser pulse energy,
(e) controlling laser pulse length,
(f) controlling laser spot velocity relative to the substrate velocity,
(g) controlling laser pulse repetition rate,
(h) controlling time between pulses,
(i) controlling laser duty cycle,
(j) controlling laser average power, or
(k) combinations of steps (a)-(j)
to obtain the plurality of light extraction features on the first surface in a pattern selected from the group consisting of random, arranged, repetitive, non-repetitive, symmetrical, and asymmetrical.

10. A glass article comprising:
a first surface and an opposing second surface,
wherein the first surface comprises a plurality of laser induced light extraction features, and
wherein the plurality of laser induced light extraction features produces a color shift Δy<0.01 per 500 mm of length.

11. The glass article of claim 10, wherein the glass article has a concentric ring failure strength of greater than about 200 MPa.

12. The glass article of claim 10, wherein an individual laser induced light extraction feature of the plurality of laser induced light extraction features comprises a diameter ranging from about 5 μm to about 1 mm and a depth ranging from about 1 μm to about 3 mm.

13. The glass article of claim 10, wherein an individual laser induced light extraction feature of the plurality of laser induced light extraction features comprises a minimum width at the first surface of between 1 μm and 500 μm, a maximum width at the first surface of between 1 μm and 500 μm, an aspect ratio at the first surface of between 1 and 10, or combinations thereof.

14. The glass article of claim 10, wherein an individual laser induced light extraction feature of the plurality of laser induced light extraction features comprises a depth and a minimum width at the first surface, and a ratio of the depth to the minimum width of 0.01 to 100.

15. The glass article of claim 10, wherein a thickness of the glass article is in a range between 0.2 mm and 4 mm.

16. The glass article of claim 15, wherein the thickness of the glass article is in a range between 0.7 mm and 2 mm.

17. The glass article of claim 10, wherein the glass article further comprises a diffusing film, a brightness enhancing film, or both.

18. The glass article of claim 10, wherein the glass article further comprises one or more light sources coupling light into one or more sides of the glass article.

19. The glass article of claim 10, wherein the plurality of laser induced light extraction features provide a light extraction uniformity of >80% across the glass article.

20. The glass article of claim 10, wherein the glass article is curved with a radius of curvature between 2 m and 6 m.

21. The glass article of claim 10, wherein the plurality of light extraction features is present on the first surface in a pattern selected from the group consisting of random, arranged, repetitive, non-repetitive, symmetrical, and asymmetrical.

22. The glass article of claim 10, wherein any one or combination of the depths, diameters, ratio of depth to diameter, and geometries of the concave light extraction features vary as a function of position on the first surface.

23. The glass article of claim 10, wherein the opposing second surface comprises a second plurality of light extraction features.

24. A display device or luminaire comprising the glass article of claim 10.
